(19) United States
(12) Patent Application Publication
(10) Pub. No.: US 2015/0186618 A1
(43) Pub. Date: Jul. 2, 2015

(54) MEDICAL RESEARCH INFORMATION EXCHANGE SYSTEM

(71) Applicant: Robert POORVIN, Kendall Park, NJ (US)

(72) Inventor: Robert POORVIN, Kendall Park, NJ (US)

(21) Appl. No.: 14/586,296

(22) Filed: Dec. 30, 2014

Related U.S. Application Data
(60) Provisional application No. 61/921,603, filed on Dec. 30, 2013.

(51) Int. Cl. G06F 19/00

(52) U.S. Cl. CPC G06F 19/36; G06F 19/322

(57) ABSTRACT

Systems, methods, and computer-readable media for exchanging medical research information are described. Medical research information may include information associated with a research project (for instance, a clinical trial) and/or the health or physical characteristics of a subject of the research project (“subject information”). In some embodiments, a medical research information exchange system (“exchange system”) may receive subject information from various information sources, such as a Health Information Exchange (HIE) or directly from a healthcare organization. The exchange system may process the subject information, for example, verifying that the subject information complies with protocols of the research project and transforming the subject information from a source format (for instance, Health Level-7 (HL7)) into a format that may be used by a research system (for instance, a Clinical Data Interchange Standards Consortium format (CDISC) format). The processed information may be provided automatically and in substantially real-time to research participants without requiring manual processing or intervention.

### CROSS REFERENCE TO RELATED APPLICATIONS

This application claims the benefit of U.S. Provisional Application No. 61/921,603 filed on Dec. 30, 2013, the contents of which are incorporated by reference in their entirety as if fully set forth herein.

### BACKGROUND

Medical research, such as clinical trials, are a required phase of the pharmaceutical and medical device development and approval process. In general, clinical trial operations are composed of two stages: data collection and information review. Data collection generally involves the collection of data or information from patients enrolled in a clinical trial by various healthcare providers and/or research professionals operating the study. Typical data may include demographics, vital signs, laboratory tests, drug doses, adverse events, and other relevant disease data points. Vast amounts of data including tables, listings, and graphs may be generated during a clinical trial to produce pre- and post-trial marketing documents that may be submitted to regulatory agencies for analysis to obtain approval to market and sell a drug or medical device.

Information review generally involves the evaluation of the information collected during the data collection phase by, for example, a clinical research associate (CRA). The information may be analyzed to ensure that each patient or subject's information conforms to the rules of the medical study, protocol design, regional practices, or the like, which may be generally referred to as “good clinical practices.” In addition, a CRA may analyze the information to verify that a patient or subject is qualified to be in the relevant medical research project. Another review process ensures that the actual dates of the events, such as lab tests, vital sign measurements, or the like correspond with what is called for in the protocol log in comparison with the data entered in the clinical database. The CRA may also verify that case report forms (CRFs) are the same as the data in a subject's source documents or other records. The CRA also checks a patient's medical records to see if there are any safety issues that have become known by research sponsor. The great amount of activity required by the CRA is time-consuming and very costly as it requires the CRA to travel to the various sites to compare patient records against the records entered in the database. In addition, if the records are not precise, then the CRA has to correct any errors or inconsistencies before submitting the results to the clinical trial database. Once the data has been analyzed, a research sponsor, such as a pharmaceutical company or medical device manufacturer, may analyze and format the data for submission to the appropriate regulatory bodies.

Data collection and information review phases performed using conventional technology and methods are extremely time consuming and require significant cost and resource investment by research sponsors. For instance, these phases often require a CRA or other research professional to personally visit data collection sites, such as healthcare facilities, doctor's offices, outpatient facilities, or the like to collect the research information. In addition, a research professional must manually parse through all of the information and submit it to a central research database for use by the research sponsor and/or regulatory agency. As such, the information is often generated, formatted, viewed, and/or transmitted multiple times to properly format and transmit the information from the information source for analysis and review by a research sponsor and/or regulatory agency. Such inefficiencies delay needed medical research results and introduce unnecessary inaccuracies and errors into the research process. Accordingly, medical research sponsors and regulatory authorities may be able to provide more timely, effective, and accurate research using systems and methods capable of providing efficient and cost-effective access to medical research information.

### SUMMARY

This disclosure is not limited to the particular systems, devices and methods described, as these may vary. The terminology used in the description is for the purpose of describing the particular versions or embodiments only, and is not intended to limit the scope

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

In an embodiment, a medical research information exchange system may comprise a processor and a non-transitory, computer-readable storage medium in operable communication with the processor. The computer-readable storage medium may contain one or more programming instructions that, when executed, cause the processor to receive research project information comprising protocol information and schedule information, receive research subject information associated with a subject from at least one information source, the research subject information being formatted in at least one source format, verify that the research subject information complies with the protocol information and the schedule information, flag research subject information that does not comply with at least one of the protocol information or the schedule information, generate standardized information by transforming the research subject information from the at least one source format to at least one standard format operational with at least one research system, and provide the standardized information to the at least one research system.

In an embodiment, a computer-implemented method for exchanging medical research information may include, by a processor, receiving research project information comprising protocol information and schedule information, receiving research subject information associated with a subject from at least one information source, the research subject information being formatted in at least one source format, verifying that the research subject information complies with the protocol information and the schedule information, flagging research subject information that does not comply with at least one of the protocol information or the schedule information, generating standardized information by transforming the research subject information from the at least one source format to at least one standard format operational with at least one research system, and providing the standardized information to the at least one research system.

In an embodiment, a computer-readable storage medium having computer-readable program code configured to exchanging medical research information embodied therewith may include computer-readable program code configured to receive research project information comprising protocol information and schedule information, computer-readable program code configured to receive research subject information associated with a subject from at least one information source, the research subject information being formatted in at least one source format, computer-readable program code configured to verify that the research subject information complies with the protocol information and the schedule information, computer-readable program code configured to flag research subject information that does not comply with at least one of the protocol information or the schedule information, computer-readable program code configured to generate standardized information by transforming the research subject information from the at least one source format to at least one standard format operational with at least one research system, and computer-readable program code configured to provide the standardized information to the at least one research system.

### BRIEF DESCRIPTION OF THE DRAWINGS

The above and other objects of the present invention will become more readily apparent from the following detailed description taken in connection with the accompanying drawings.

FIG. 1 depicts an illustrative medical research information exchange system according to some embodiments.

FIG. 2 depicts an illustrative medical research information exchange system according to some embodiments.

FIG. 3 depicts an illustrative medical research information exchange system according to some embodiments.

FIG. 4 depicts a flow diagram of an illustrative method for exchanging medical research information that may be performed by a medical research information exchange system according to some embodiments.

FIG. 5 illustrates various embodiments of a computing device for implementing the various methods and processes described herein.

### DETAILED DESCRIPTION

The described technology generally relates to systems, methods, and non-transitory computer-readable media for the collection and review of medical research information obtained as part of a medical research process (“medical research information”). In particular, some embodiments provide a medical research information exchange system (“exchange system”) configured to collect, analyze, examine, evaluate, format, transmit, verify, exchange, store and/or otherwise process medical research information. In some embodiments, systems and methods may be configured for providing and exchanging data between a service provider and a sponsor of a study or clinical trial. In some embodiments, systems and methods may be configured for capturing medical research information directly from a subject's source documents and/or records at the point of care for clinical data collection and information review. In some embodiments, subject medical research information may be retrieved from health care organizations, such as hospitals, doctor's offices, imaging centers, or electronic health records systems, for example, via a Health Information Exchange (HIE or directly from the healthcare organization. In some embodiments, patient clinical data may be anonymized, extracted, transformed, converted, and loaded into a research sponsor's databases.

Medical research information may include any type of information associated with the health or physical characteristics of a subject (or “patient”) and/or group of subjects associated with a medical research project (“research subject information”), including, without limitation, name, address, age, gender, demographic information, weight, height, medications, surgeries and other medical procedures (for example, diagnostic tests, diagnostic imaging tests, or the like), occupation, past and current medical conditions, family history, patient description of health condition, medical research professional description of health condition, symptoms, and/or dates and times associated with any medical research information. In addition, medical research information may include any type of information associated with the protocols, guidelines, rules, regulations, standards, schedules, or other requirements of a medical research project (“research project information”).

The research subject information may be obtained as part of a medical research project and/or may have been obtained prior to the medical research project (for instance, subject medical history, historical medical information repository, or the like). A medical research project may generally include any type of medical research, such as a clinical trial, interventional studies, or any other type of medical research now known to those having ordinary skill in the art or developed in the future. The research subject information may be obtained by the exchange system from various sources (“information sources”), including, but not limited to a health information exchange (HIE), healthcare information and management systems (HIMS), electronic medical record (EMR) or electronic health record (EHR) systems, radiology information systems (RIS), picture archiving and communications system (PACS), government healthcare information system (for example, the Centers for Medicare and Medicaid Management system (CMS)), a medical library, a third-party medical database, employers, laboratories, home healthcare agencies, pharmacies, physician groups, hospitals, care managers, governments, community health services, care centers, payers, imaging centers, healthcare providers or (“healthcare organizations”), healthcare facilities, insurance provider, or the like.

A conventional medical research data exchange method may involve data exchange between healthcare providers and the sponsor of the medical research, such as pharmaceutical companies and/or medical device manufacturers. The healthcare providers may include various service providers that collect, maintain and use data from a subject or patient, including but not limited to, test results, medical images, medical records, bedside data, or the like. In a traditional setting this data may be captured and maintained on paper, electronically, and/or a combination thereof and stored as paper files and/or electronic records in one or more proprietary data formats. In order for a sponsor use this data in any meaningful way, a CRA or other medical or research professional must travel to the physical location where the records are stored. The CRA must then analyze and compare the data to data already collected and kept in a study database. In addition, the CRA must manually re-enter and/or convert the data into a format that can be readily used by protocol databases used by the sponsor and/or relevant regulatory agencies, such as a Clinical Trials Database System (CTMS). After the data have been re-entered and processed in the appropriate formats in a Clinical Database System (CDMS), the sponsor may submit relevant data to the regulatory body reviewing the study. Once the regulatory body approves of the trial drug or device and other regulatory requirements are satisfied, the sponsor can begin to market and sell the drug or device to the public.

The exchange system described according to some embodiments provides multiple technological advantages and technical effects on processes and techniques, including processes and techniques external to the exchange system. One non-limiting technological advantage is that the exchange system may access subject information from multiple information sources and provide processed, verified, and formatted subject information to research sponsor and/or regulatory agency systems (“research systems”) in a standardized format, including in real-time or in substantially real-time. Such methods and systems are not possible using conventional processes and technology because, for instance, conventional systems would require too much time to be effective and practical when providing medical research analysis and results to research systems during the various phases of a research project.

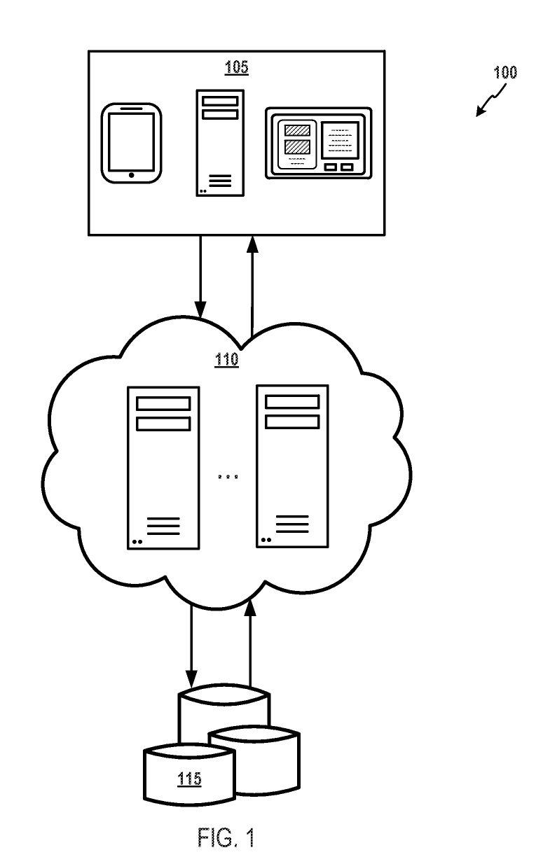

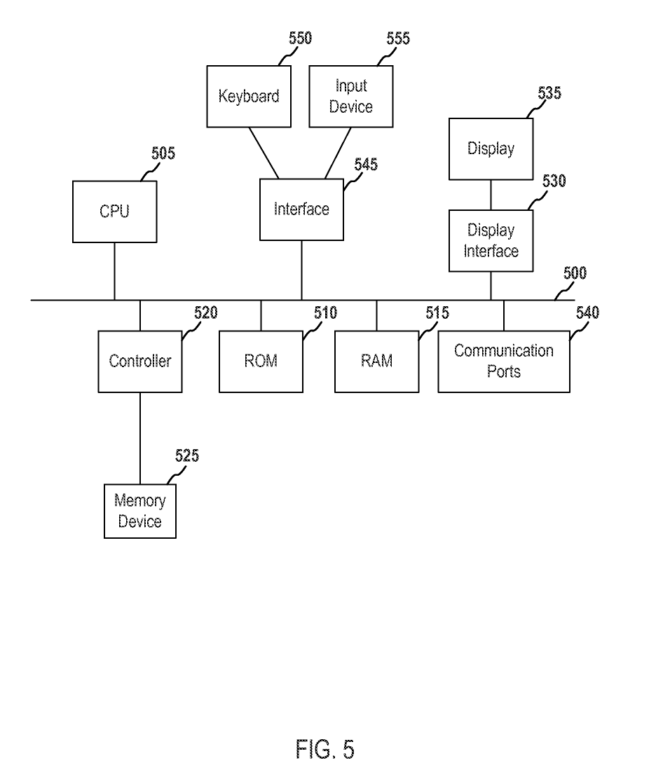

FIG. 1 depicts an illustrative exchange system according to some embodiments. As shown in FIG. 1, the exchange system 100 may include one or more server logic devices 110, which may generally include a processor, a non-transitory memory or other storage device for housing programming instructions, data or information regarding one or more applications, and other hardware, including, for example, the central processing unit (CPU) 505, read only memory (ROM) 510, random access memory (RAM) 515, communication ports 540, controller 520, and/or memory device 525 depicted in FIG. 5 and described below in reference thereto.

In some embodiments, the programming instructions may include a medical research information exchange application (the “exchange application”) configured to, among other things, access, analyze, format, and transmit medical research information. The server logic devices 110 may be in operable communication with client logic devices 105, including, but not limited to, server computing devices, personal computers (PCs), kiosk computing devices, mobile computing devices, laptop computers, smartphones, personal digital assistants (PDAs), tablet computing devices, or any other logic and/or computing devices now known or developed in the future.

In some embodiments, the exchange application may be accessible through various platforms, such as a client application, a web-based application, over the Internet, and/or a mobile application (for example, a “mobile app” or “app”). According to some embodiments, the exchange application may be configured to operate on each client logic device 105 and/or to operate on a server computing device accessible to logic devices over a network, such as the Internet. All or some of the files, data and/or processes (for example, medical research information, analysis processes, or the like) used for accessing and/or the processing of medical research information may be stored locally on each client logic device 105 and/or stored in a central location, such as server logic devices 110, and accessible over a network.

In an embodiment, one or more information sources 115 may be accessible by the client logic devices 105 and/or server logic devices 110. The information sources 115 may include any source of research project information and/or subject information capable of operating according to some embodiments. Illustrative and non-limiting examples of healthcare information sources 115 may include, HIE, HIMS, EHR, EMR, RIS, PACS, CMS, a medical library, a third-party medical database, employers, laboratories, home healthcare agencies, pharmacies, physician groups, hospitals, care managers, governments, community health services, care centers, payers, imaging centers, healthcare facilities, insurance records, research sponsors, regulatory agencies, pharmaceutical companies, medical device manufacturers, or the like. In some embodiments, the healthcare information sources 115 may include research project information. In some embodiments, the healthcare information sources 115 may include research subject information.

In some embodiments, the exchange system 100 may utilize HIE associations and other relationships to transmit and receive medical research information. In some embodiments, the HIE and other relationships may be configured to provide EHR associations between various medical information sources 115, including, but not limited to employers, laboratories, home healthcare agencies, pharmacies, physician groups, hospitals, care managers, governments, community health services, care centers, payers, and imaging centers.

Although the one or more data stores 115 are depicted as being separate from the logic devices 105, 110, embodiments are not so limited, as all or some of the one or more data stores may be stored in one or more of the logic devices.

As described in more detail below, the exchange application may process the medical research information received from the data stores 115. In some embodiments, the exchange application may verify that the research subject information complies with the research project information. For example, the exchange application may be configured to analyze the research subject information using the research project information to ensure that the subject may be included in the medical research project. In another example, the exchange application may be configured to analyze the research subject information using the research project information to verify that the research subject information has been collected according to required protocols, guidelines, schedules, or the like. In this manner, the exchange application may be configured to determine if there are any issues, errors, discrepancies, or the like (“discrepancies”) in the research subject information.

In some embodiments, the medical research information may be in a source format, such as proprietary software formats (for instance, Microsoft® Excel®) or data standard formats (for instance, Health Level-7 (HL7)). In some embodiments, the exchange system 100 may receive medical research information in multiple source formats. In some embodiments, the exchange application may be configured to transform the medical research information into one or more standardized subject information formats that may be used by one or more research systems. A non-limiting example of a standardized subject information format may include the Clinical Data Interchange Standards Consortium (CDISC) format or other CDISC-compatible formats.

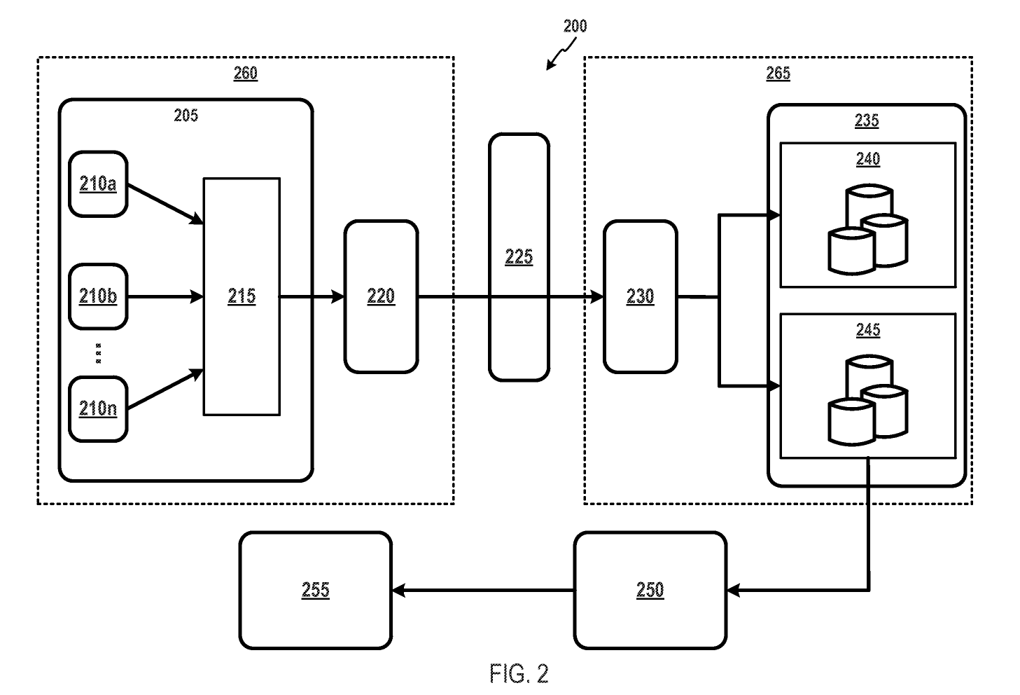

FIG. 2 depicts an illustrative exchange system according to some embodiments. As shown in FIG. 2, an exchange system 200 may include an information source 215 associated with a healthcare provider (within the “healthcare world” 260), such as an EHR configured to receive medical research information from various data sources 210a-210n. Illustrative data sources 210a-210n may include medical test data (for instance, ECG data), laboratory tests, diagnostic tests (for instance, x-ray images and/or results), bedside data, or the like. The medical research information may be obtained by the exchange system 200 via an exchange system platform 230 through an HIE 220 via an automated patient data collection process 225. The exchange system platform 230 may include a server logic device executing the exchange application. The exchange system platform 230 may be associated with a research sponsor or research system (for instance, within the “sponsor world” 266, such as the “pharmaceutical world” for a pharmaceutical company research sponsor). In some embodiments, the medical research information may be formatted within the HIE 220 in one or more source formats, such as HL7. The exchange system platform 230 may be configured to transform the medical research information from the source format to a standardized format, such as a regulatory formatted data (for instance, CDISC).

The transformed data may be transmitted by the exchange system platform 230 to one or more research systems 240, 245. Non-limiting examples of a research system may include a clinical trials database system (for instance, a CTMS) 240 or a clinical database system (for instance, a CDMS) 245. This transformed data is then used for the clinical data collection and information review efforts of the research sponsor. The research systems 240, 245 of the research sponsor may transmit the medical research information to one or more regulatory agencies 250, such as the Food and Drug Administration (FDA) and/or National Institutes of Health (NIH) in the United States, the European Medicines Agency (EMEA) in the European Union, the pharmaceuticals and medical devices agency (PMDA) in Japan, or the like. Approval of the pharmaceutical or medical device that is the subject of the medical research project by the regulatory agencies 250 may allow the pharmaceutical or medical device to be marketed 255 within the approved jurisdictions. In this manner, the exchange system's 200 automated data extraction and transformation may greatly reduce the amount of data entry errors, providing real time viewing of patient medical records without on-site visits, decreasing the time and cost to deliver required formatted data for analysis and submission, and increasing the number of months available for exclusive sales.

According to some embodiments, conversion of medical research information from a source format (for instance, HL7) to a standardized format (for instance, CDISC) requires the secure deliver of the medical research information (for instance, subject information) from an information source to the exchange system. In some embodiments, the secure delivery of subject information may be implemented via an HIE entity associated with an information source or even the actual healthcare organization, such as a healthcare facility, hospital, doctor's office, clinic, imaging center, or the like. As is known to those having ordinary skill in the art, the subject may be required to sign an Informed Consent Agreement (ICA) authorizing the subject information data to be released for the purposes of the research project, such as a clinical trial. In some embodiments, the exchange application may be configured to determine whether the subject information indicates that such proper authorizations have been completed by the subject.

The subject information received by the exchange system may be verified to ensure, among other things, that the patient is correctly enrolled in the research project (for instance, a clinical study or protocol). In some embodiments, if the subject information is not verified, then the exchange system will notify the information source, such as an HIE entity, that the subject information was not verified. In some embodiments, if the subject information is verified, then the subject information may be stored into a subject information database for further processing. Such verification procedures ensure, among other things, that the exchange system is compliant with privacy and patient rights, rules, and/or regulations.

In some embodiments, the medical research information may include schedule information associated with a schedule of events for the research project, including, without limitation, medical appointments, medication and/or prescription schedules, diagnostic tests, or the like. In some embodiments, the exchange application may be configured to map or overlay the schedule of events onto the subject information and to label the subject information according to the schedule information. For example, the schedule information may indicate that the research project includes four visits with a medical professional, each with a specific set of events (for example, “Visit 1” for medical history, vital sign, and lab collection events). In this example, the exchange application may label a first medical professional appointment in the subject information as “Visit 1” and determine whether all required events were recorded. The exchange application may flag the subject information if it does not comply with any portion of the schedule information, such as the number and/or timing of medical professional appointment schedules, appointment events, and/or results or information outside of required or expected results for the appointment events (for instance, a blood sugar reading outside of a threshold value for subject participants).

In some embodiments, a research system may be provided with access to the subject information, including in a source format. In some embodiments, a research system may be provided with access to the subject information verified against the schedule information. For example, a CRA or other research professional may be provided with access to HL7 data via a web-based platform, the Internet, a client application, or other interface. The CRA may review the HL7 data and may annotate the HL7 data, for instance, to note any discrepancies and/or any appropriate actions to be taken with regard to the HL7 data according to the research project protocol procedures.

The research subject information may be transformed into a standardized information by transforming the research subject information from a source format to a standardized format using various processes. In some embodiments, the exchange application may be configured to transform research subject information in a HL7 format into a CDISC Operational Data Model (ODM) format and/or a Study Data Tabulation Model (SDTM). In some embodiments, the exchange application may include a format transformation component for transforming the research subject information from a source format to a standardized format, for instance, used by a research system. In some embodiments, the format transformation component may include a domain analysis model or “mapping dictionary” tool, such as a Biomedical Research Integrated Domain Group (BRIDG) (for instance, BRIDG Release 3.2). In some embodiments, the exchange application may transform research subject information in a HL7 format to CDISC ODM and/or SDTM standardized information using BRIDG Release 3.2. In some embodiments, the exchange application may be configured to analyze the source format of research subject information in view of one or more standardized formats and to determine a model for mapping, converting, translating, or otherwise transforming the research subject information from the source format to the one or more standardized formats. In this manner, the exchange application may be configured to transform research subject information into standardized information using existing models (for instance, BRIDG Release 3.2) or models generated by the exchange application.

In some embodiments, the exchange application may remove any personal identifiable information (PHI) from (or “anonymize”) the research subject information. In some embodiments, the research subject information may include a PHI component configured to access applicable protocols, regulations, laws, and/or rules for anonymizing the research subject information, such as research subject protocols, the Health Insurance Portability and Accountability Act (HIPAA). In this manner, the exchange application may be configured to anonymize research subject information according to various protocols. In some embodiments, the exchange application may be configured to automatically analyze the research subject information to determine whether the research subject information includes any errors, discrepancies, inconsistencies, or the like. Any such discrepancies may be identified and flagged by the exchange application in the research subject information. In some embodiments, the exchange application may be configured to resolve various discrepancies, for instance, according to good clinical practice and/or research project protocols and practices.

In some embodiments, the anonymized, standardized information may be transferred to a research project database, such as a CDISC clinical staging database for further review. In some embodiments, a research system and/or research sponsor may be given customized access to the research project database, such as a CDISC clinical staging database. In some embodiments, a research sponsor data manager (DM) may be given customized access to the research project database. In this manner, a DM may be able to review this transformed information and then upload it into a localized database (for instance, a CDMS) at their discretion. In some embodiments, a CRA or other research professional may be given customized access the research project database, such as a CDISC clinical staging database for review and loading into a localized database, such as a CTMS.

In some embodiments, the data records of the research subject information and/or the standardized information may include status flags for each processing step, including, without limitation, an anonymized status flag, a discrepancy check status flag, a standardized status flag, or the like. In some embodiments, the status flag may be configured to indicate whether a particular step has been completed, whether the step was successful, and reasons for the success and/or failure of a step. In this manner, an audit trail may be established for the research subject information and/or standardized information as the data flows from the information source to the research system. In some embodiments, the status flags may include or may be associated with text or other information that may be used to provide information relating to the status flag, such as reasons for failure and/or success and/or annotations. In some embodiments, at least a portion of the status flags may be configured according to various protocols, rules, regulations, laws or the like, such as HIPAA, Health Information Technology for Economic and Clinical Health (HITECH), 21 Code of Federal Regulations (C.F.R.) §11, and/or research sponsor requested status flags.

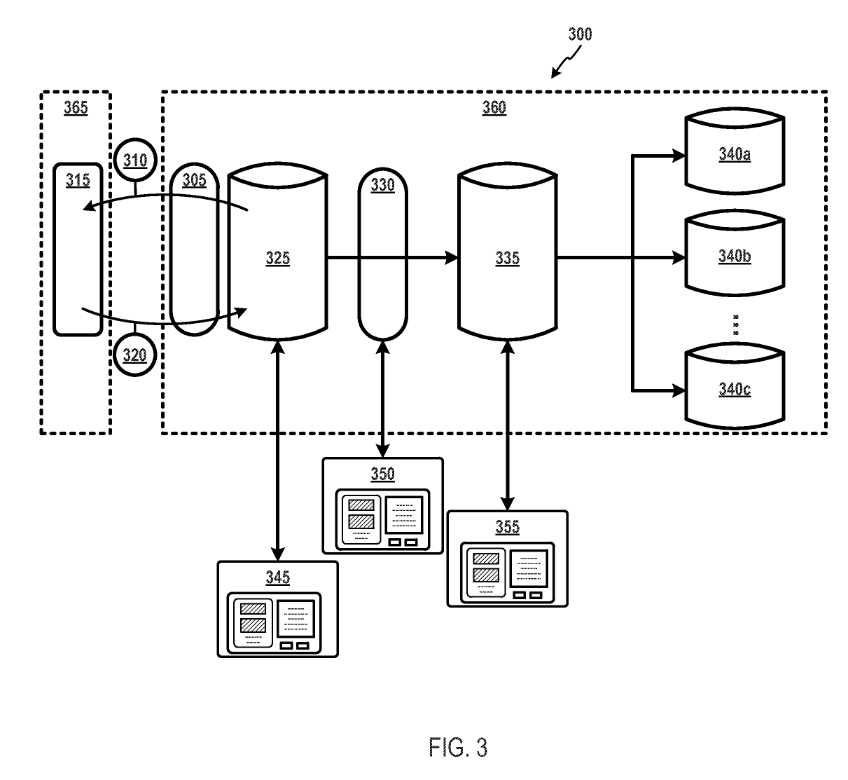

FIG. 3 depicts an illustrative exchange system according to some embodiments. As shown in FIG. 3, the exchange system 300 may operate within an exchange system environment 360. The exchange system 300 may execute an information request process 305 configured to transmit a research subject information request 310 to an information source 315 within an information source environment 365. In some embodiments, the subject information request 310 may include a patient records request from an information source 315 configured as an HIE. In some embodiments, the subject information request 310 may be sent automatically by the exchange system 300, for example, according to a set of rules or protocols, and/or may be triggered manually by an operator of the exchange system. The information source 315 may respond to the subject information request 310 with a research subject information transmission 320 that may include research subject information. In some embodiments, the research subject information transmission 320 may include patient records in a source format, such as HL7 or a information source proprietary format.

The research subject information received in the research subject information transmission 320 may be stored in a research subject information database 325. In some embodiments, the research subject information database 325 may be configured as a patient HL7 message database. The exchange system 300 may execute an information processing process 330 to process the research subject information (for instance, to generate “processed information”). Illustrative processing may include anonymizing, verifying, transforming the research subject information into a standardized format, and/or other processing steps according to some embodiments described herein. In some embodiments, the information processing process 330 may be configured to filter the research subject information and/or processed versions thereof according to various rules or protocols. For instance, the information processing process 330 may be configured to filter out non-compliant research subject information and/or research subject information associated with subjects that do not qualify for the research project.

The processed research subject information (standardized information) may be stored in a standardized information database 335. In some embodiments, the information processing process 330 may be configured to use a model (for instance, BRIDG Release 3.2) to convert the research subject information from a source format (for instance, HL7) to a standardized format (for instance, CDISC). The processed, standardized information may be further processed and/or filtered according to some embodiments described herein and stored in one or more research project databases 340a-n, such as one or more STDM databases.

As shown in FIG. 3, various entities may have access to information within the exchange system environment 360. In some embodiments, such access may be selective and/or limited based on the type of information that may be accessed and/or methods of access. For example, a CRA 345 may have access to the research subject information stored in the research subject information database 325 through a source document viewer application or web-based interface. In another example, an investigator 350, such as a physician responsible for providing patient care, may have access to exchange system information, for instance, for visit data assignment and/or investigator sign-off purposes. In a further example, a data manager 355 may have access to the standardized information database 335, for instance, throughout the information intake and conversion process.

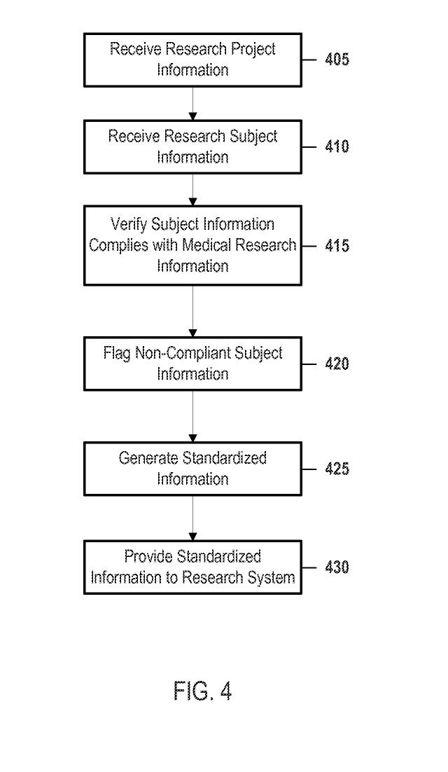

FIG. 4 depicts a flow diagram of an illustrative method for exchanging medical research information that may be performed by the exchange system, such as through a server logic device (for instance, server logic device 110 of FIG. 1), arranged in accordance with at least some embodiments described herein. Example methods may include one or more operations, functions or actions as illustrated by one or more of blocks 405, 410, 415, 420, 425, and/or 430. The operations described in blocks 405-430 may also be stored as computer-executable instructions in a computer-readable medium such the memory elements 510, 515, and 525 depicted in FIG. 5. Although illustrated as discrete blocks, various blocks may be divided into additional blocks, combined into fewer blocks, or eliminated, depending on the desired implementation.

As shown in FIG. 4, an exchange system may receive 405 research project information. In some embodiments, the research project information may include information associated with the protocols, guidelines, rules, laws, schedules, or the like associated with a particular research project. The exchange system may receive 410 research subject information associated with a research subject. The exchange system may verify 415 that the subject information complies with the medical research information. For instance, the exchange system may use the research project information to verify 415 that the subject is eligible to participate in the research project, whether the research project information contains any errors or discrepancies, or the like. In some embodiments, the exchange system may flag 420 non-compliant research subject information. The exchange system may generate 425 standardized subject information by converting the research subject information, such as the processed information obtained from verification 415 of the research subject information, from a source format to a standardized format. The exchange system may provide 430 access to the standardized information to a research system, such as a research sponsor system.

FIG. 5 depicts a block diagram of exemplary internal hardware that may be used to contain or implement the various computer processes and systems as discussed above. A bus 500 serves as the main information highway interconnecting the other illustrated components of the hardware. CPU 505 is the central processing unit of the system, performing calculations and logic operations required to execute a program. CPU 505 is an exemplary processing device, computing device or processor as such terms are used within this disclosure. Read only memory (ROM) 530 and random access memory (RAM) 535 constitute exemplary memory devices.

A controller 520 interfaces with one or more optional memory devices 525 via the system bus 500. These memory devices 525 may include, for example, an external or internal DVD drive, a CD ROM drive, a hard drive, flash memory, a USB drive or the like. As indicated previously, these various drives and controllers are optional devices. Additionally, the memory devices 525 may be configured to include individual files for storing any software modules or instructions, auxiliary data, common files for storing groups of results or auxiliary, or one or more databases for storing the result information, auxiliary data, and related information as discussed above.

Program instructions, software or interactive modules for performing any of the functional steps associated with the determination, configuration, transmission, decoding, or the like of the presentation settings as described above may be stored in the ROM 530 and/or the RAM 535. Optionally, the program instructions may be stored on a tangible computer-readable medium such as a compact disk, a digital disk, flash memory, a memory card, a USB drive, an optical disc storage medium, such as a Blu-ray™ disc, and/or other recording medium.

An optional display interface 530 can permit information from the bus 500 to be displayed on the display 535 in audio, visual, graphic or alphanumeric format. The information may include information related to a current job ticket and associated tasks. Communication with external devices may occur using various communication ports 540. An exemplary communication port 540 may be attached to a communications network, such as the Internet or a local area network.

The hardware may also include an interface 545 which allows for receipt of data from input devices such as a keyboard 550 or other input device 555 such as a mouse, a joystick, a touch screen, a remote control, a pointing device, a video input device and/or an audio input device.

As described herein, systems and methods configured according to some embodiments described herein provide numerous advantages over traditional systems and processes of exchanging data between a healthcare provider and a trial sponsor. Illustrative and non-restrictive examples of such technological advantages include, without limitation, the use of the HIE as a conduit to obtain patient source documents/data; development of custom program/web pages to display patient source data for clinical trials information review by CRA/monitors from remote locations; development of custom program/webpages configured to display subject research information (for instance, patient source data) with an overlay of a protocol schedule of clinical data collection events (for instance, date of randomization, date of first dose, Visit 1 ECG, Visit 2 ECG, Visit 1 Labs, date of termination, or the like); development of custom program code to schedule automated data extraction requests to HIE sources (for instance, Continuity of Care Record format (CCR), Continuity of Care Document format (CCD), Clinical Document Architecture format (CDA)); development of custom program code to transform HL7 data into CDISC data (for instance, ODM format, SDTM format); development of custom program code to load extracted and transformed HL7 (for instance, CDISC data into Clinical trials systems, CTMS used by CRAs/Monitors, CDMS used by DMs, Electronic Data Collection systems (EDC) used by DMs and site personnel, Adverse Event Safety systems (SAE) used by drug/device safety departments, Clinical Data Warehouses (CDW) used by drug/device company personnel); develop custom code to integrate metadata of clinical systems to the exchange system (for instance, CTMS, CDMS, EDC, SAE, and CDW), development of custom code to add new patients to automated HIE extraction process; development of custom code to validate first time patient data retrieval from HIE; and development of custom EHR Note forms and EHR plug-in modules to capture protocol specific data within EHR system.

It will be appreciated that various of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which alternatives, variations and improvements are also intended to be encompassed by some embodiments described herein.

What is claimed is:

1. A medical research information exchange system comprising:
a processor; and
a non-transitory, computer-readable storage medium in operable communication with the processor, wherein the computer-readable storage medium contains one or more programming instructions that, when executed, cause the processor to:
receive research project information comprising protocol information and schedule information,
receive research subject information associated with a subject from at least one information source, the research subject information being formatted in at least one source format,
verify that the research subject information complies with the protocol information and the schedule information,
flag research subject information that does not comply with at least one of the protocol information or the schedule information,
generate standardized information by transforming the research subject information from the at least one source format to at least one standard format operational with at least one research system, and
provide the standardized information to the at least one research system.

2. The system of claim 1, wherein the research project information is associated with a clinical trial.

3. The system of claim 1, wherein the at least one information source comprises a health information exchange.

4. The system of claim 1, wherein the at least one information source comprises at least one of a healthcare information and management system, an electronic medical record system, a radiology information system, a picture archiving and communications system, a Centers for Medicare and Medicaid Management system, a healthcare provider, a healthcare facility, and an insurance provider.

5. The system of claim 1, wherein the computer-readable storage medium contains one or more programming instructions that, when executed, further cause the processor to:
generate a plurality of status flags associated with processing steps of the research subject information; and
generate an audit trail based on the plurality of status flags.

6. The system of claim 1, wherein the computer-readable storage medium contains one or more programming instructions that, when executed, further cause the processor to resolve discrepancies associated with research subject information that does not comply with at least one of the protocol information or the schedule information.

7. The system of claim 1, wherein the at least one source format comprises a Health Level-7 format.

8. The system of claim 1, wherein the at least one standardized format comprises at least one of a Clinical Data Interchange Standards Consortium format and a Clinical Trials Database System format.

9. A computer-implemented method for exchanging medical research information, the method comprising, by a processor:
receiving research project information comprising protocol information and schedule information;
receiving research subject information associated with a subject from at least one information source, the research subject information being formatted in at least one source format;
verifying that the research subject information complies with the protocol information and the schedule information;
flagging research subject information that does not comply with at least one of the protocol information or the schedule information;
generating standardized information by transforming the research subject information from the at least one source format to at least one standard format operational with at least one research system; and
providing the standardized information to the at least one research system.

10. The method of claim 9, wherein the research project information is associated with a clinical trial.

11. The method of claim 9, wherein the at least one information source comprises a health information exchange.

12. The method of claim 9, wherein the at least one information source comprises at least one of a healthcare information and management system, an electronic medical record system, a radiology information system, a picture archiving and communications system, a Centers for Medicare and Medicaid Management system, a healthcare provider, a healthcare facility, and an insurance provider.

13. The method of claim 9, further comprising:
generating a plurality of status flags associated with processing steps of the research subject information, and
generating an audit trail based on the plurality of status flags.

14. The method of claim 9, further comprising resolving discrepancies associated with research subject information that does not comply with at least one of the protocol information or the schedule information.

15. The method of claim 9, wherein the at least one source format comprises a Health Level-7 format.

16. The method of claim 9, wherein the at least one standardized format comprises at least one of a Clinical Data Interchange Standards Consortium format and a Clinical Trials Database System format.

17. A computer-readable storage medium having computer-readable program code configured to exchanging medical research information embodied therewith, the computer-readable program code comprising:
computer-readable program code configured to receive research project information comprising protocol information and schedule information;
computer-readable program code configured to receive research subject information associated with a subject from at least one information source, the research subject information being formatted in at least one source format;
computer-readable program code configured to verify that the research subject information complies with the protocol information and the schedule information;
computer-readable program code configured to flag research subject information that does not comply with at least one of the protocol information or the schedule information;
computer-readable program code configured to generate standardized information by transforming the research subject information from the at least one source format to at least one standard format operational with at least one research system; and
computer-readable program code configured to provide the standardized information to the at least one research system.

18. The computer-readable storage medium of claim 17, wherein the at least one information source comprises a health information exchange or a direct healthcare organization.

19. The computer-readable storage medium of claim 17, further comprising:
computer-readable program code configured to generate a plurality of status flags associated with processing steps of the research subject information; and
computer-readable program code configured to generate an audit trail based on the plurality of status flags.

20. The computer-readable storage medium of claim 17, wherein the at least one source format comprises a Health Level-7 format and the at least one standardized format comprises at least one of a Clinical Data Interchange Standards Consortium format and a Clinical Trials Database System format.
